(19) United States
(12) Patent Application Publication
(10) Pub. No.: US 2005/0176612 A1
(43) Pub. Date: Aug. 11, 2005

(54) Bleaching composition

(76) Inventors: Stephen Norman Batchelor, Chester (GB); Lynette Fairclough, Bebington (GB)

Correspondence Address: KIRKPATRICK & LOCKHART NICHOLSON GRAHAM LLP, 535 SMITHFIELD STREET, PITTSBURGH, PA, 15222, US

(21) Appl. No.: 10/506,745

(22) PCT Filed: Feb. 12, 2003
(86) PCT No.: PCT/EP03/01521

(30) Foreign Application Priority Data
Mar. 6, 2002 (GB) 0205276.9

(51) Int. Cl. C11D 9/42

(52) U.S. Cl. 510/302

(57) ABSTRACT

The invention provides a laundry bleaching composition comprising a macrocyclic (tetra) amido N-donor ligand which forms a complex with a transition metal, the ligand metal complex being capable of catalysing bleaching of dyestuffs in solution, and, a radical initiator. These components provide a synergic bleaching benefit.

### TECHNICAL FIELD

The present invention relates to bleaching compositions and more particularly to bleaching compositions suitable for use in fabric laundry.

### BACKGROUND OF THE INVENTION

Bleaching agents typically present in laundry detergents include percarbonates and/or perborates. These can release hydrogen peroxide, and can also act as sources of hydrogen peroxide and/or other peroxyl species for more complex bleaching mechanisms. The purpose of all this is to bleach stains. In the present specification, both vagrant dyes and coloured materials found in stains and soiling are referred to collectively as ‘stains’ unless the context demands otherwise.

In recent years, several new approaches have been taken to bleaching fabrics during the laundry process.

Oxidation catalysts comprising metal-complexes have been proposed for use in laundry compositions as components of a bleaching system. These catalysts typically activate H₂O₂ or other peroxygen sources. One proposed use of these catalysts has been the bleaching of dyestuffs released from articles being laundered. If these dyestuffs are not removed from the wash liquor then they will re-deposit onto articles and cause a loss of colour definition or even catastrophic damage to ‘white’ articles.

A particular catalyst is disclosed in WO 98/03263, filed 21 Jul. 1997, (Collins). This comprises a macrocyclic (tetra) amido N-donor. The macrocycle is capable of complexing with a metal ion, for example an iron III or IV. The complex also comprises axial ligands, for example as chloride or water, and one or more counter ions, for example tetraphenylphosphonium and tetraethylammonium.

U.S. Pat. No. 5,853,428, filed Feb. 24, 1997, (Collins) discloses use of similar catalysts in laundry detergent compositions. In both these citations the addition of hydrogen peroxide, or a source thereof, is envisaged as a means of activating the catalyst.

Bleaching catalysts capable of bleaching effectively in the absence of an added peroxyl sources have recently become the focus of some interest, as disclosed for example in WO9965905; WO0012667; WO0012808; WO0029537, and, WO0060045. It is believed that these catalysts have the capability to use atmospheric oxygen, either directly or indirectly, as a source of oxidising equivalents.

Recently, radical initiators have been found to be effective laundry photo-bleaches: UK patent application 9917451.8 teaches their use from main wash detergent powders and liquids, where the initiators are intimately mixed into the powder or liquids. These materials are effective at low levels as bleaching agents for stains.

### SUMMARY OF THE INVENTION

We have now determined that the combination of a macrocyclic (tetra) amido N-donor catalytic metal-ligand complex and a radical initiator provides surprisingly superior results to either system used alone.

Accordingly, the present invention provides a bleaching composition which comprises:
a) a macrocyclic (tetra) amido N-donor ligand which forms a complex with a transition metal, the ligand metal complex being capable of catalysing bleaching of dyestuffs in solution, and,
b) a radical initiator.

The mechanism why which the invention works is not fully understood, although it is believed that catalyst chemically weakens the stain, subsequently allowing a much greater bleaching action by the radicals.

Preferably the radical initiator is a radical photo-initiator. Thermal and chemical radical initiators can also be employed, although the photo-initiators have particular benefits.

It is believed that as the photo-initiator is most active during drying, this prevents attack by radicals generated by the photo-initiator on the metal-ligand bleaching catalyst during the wash.

The present invention extends to a method of bleaching a substrate comprising applying to the substrate, in an aqueous medium, the bleaching composition according to the present invention.

The present invention extends to a commercial package comprising the bleaching composition according to the present invention together with instructions for its use.

The bleaching composition may be contacted to the textile fabric in any suitable manner. Typically, it will be applied as a wash liquor for laundry cleaning. In particular, the treatment may be effected in a washing/drying cycle for cleaning laundry.

Any suitable textile that is susceptible to bleaching or one that one might wish to subject to bleaching may be used. Preferably the textile is a laundry fabric or garment.

In particular the treatment may be effected in, or as an adjunct to, an essentially conventional wash cycle for cleaning laundry. More preferably, the treatment is carried out in an aqueous detergent wash liquor. The bleaching composition can be delivered into the wash liquor from a powder, granule, pellet, tablet, block, bar or other such solid form. The solid form can comprise a carrier, which can be particulate, sheet-like or comprise a three-dimensional object. The carrier can be dispersible or soluble in the wash liquor or may remain substantially intact. In other embodiments, the bleaching composition can be delivered into the wash liquor from a paste, gel or liquid concentrate.

Delivery of the composition from a liquid concentrate confers certain specific advantages. In particular it is difficult to prepare stable liquid bleaching compositions for laundry. As the preferred catalysts and radical initiators are long-lived it is envisaged that the compositions will have excellent storage stability.

A unit dose as used herein is a particular amount of the bleaching composition used for a type of wash. The unit dose may be in the form of a defined volume of powder, granules or tablet.

### DETAILED DESCRIPTION OF THE INVENTION

In order that the invention may be further understood it is described below with reference to certain preferred features.

The Bleach Catalyst:

Preferred catalysts are the macrocyclic (tetra) amido N-donors disclosed in WO 98/03263.

The amount of catalyst in the detergent composition is typically sufficient to provide a concentration in the wash liquor of generally 0.005 μm to 100 μm, preferably from 0.025 μM to 50 μM, more preferably from 0.05 μM to 10 μM.

Preferred metal-complexed ligands are those having the structure as shown in general formula 1: 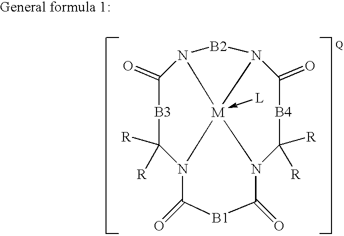
wherein:
B₁, B₃ and B₄ each represent a bridging group having zero, one two or three carbon containing nodes for substitution, and B₂ represents a bridging group having at least one carbon containing node for substitution, each said node containing a C(R), C(R₁) (R₂) or C(R)₂,
each R substituent is the same is the same or different from the remaining R substituents, and
   (i) is selected from the group consisting of alkyl, alkenyl, cycloalkyl, cycloalkenyl, aryl, alkynyl, alkylaryl, halogen, alkoxy, phenoxy and combinations thereof, or
   (ii) form a substituted or unsubstituted benzene ring of which two carbons on the ring form nodes in the B-unit;
M is a transition metal ion;
L is an axial ligand; and,
Q is an alkali metal or tetra-alkyl ammonium or tetra-phenyl phosphonium counter-ion.

Preferably, the axial ligand is selected from the group consisting of water and halide. Particularly preferred axial ligands are water and chloride.

It is within the scope of the present invention to have a bleach activator, wherein M is selected from the group consisting of Fe, Mn, Cr, Cu, Co, Ni, Mo, V, Zn and W.

The most preferred catalyst is that in which the ligand is 5,6-benzo-3,8,11,13-tetraoxo-2,2,9,9,12,12-hexamethyl-1,4,7,10-tetraaza-cyclo-tridecane. The ligand is also known as 3,4,8,9-tetrahydro-3,3,6,6,9,9-hexa-methyl-1H-1,4,8,11-benzotetraazocyclotridecane-2,5,7,10(6H,11H) tetrone.

The axial ligand ‘L’ is preferably water or chloride. The counter-ion ‘Q’ is preferably lithium.

It is possible to include an enhancer for the catalyst in the composition. Preferably the enhancers are nitrogen-containing organic molecules. More preferably, the enhancer compounds are of the general formula one, shown below: 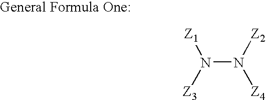
wherein:
Z₁ and Z₂ are electron-withdrawing groups, independently selected from the group consisting of optionally substituted alkyl/(hetero) (poly)aryl-, -sulfone, -sulfoxide, -sulfonate, -carbonyl, -oxalyl, -amidoxalyl, -hydrazidoxalyl, -carboxyl and esters and salts thereof, -amidyl, -hydrazidyl, and nitrile.

Z₃ and Z₄ are hydrogen, or are absent when the bonding between Z₁ or Z₂ and the adjacent nitrogen in the general form is a pi-bond.

In preferred enhancers Z₃ and Z₄ are both hydrogen (thereby forming a hydrazino compound), or Z₃ and Z₄ are both absent (thereby forming an azino compound).

Peroxygen Sources:

If the metal-ligand complex is capable of eventually deriving its oxidising equivalents from atmospheric oxygen then it is not necessary to include a source of peroxygen in the composition of the invention.

In an alternative series of embodiments the detergent composition also contains a peroxygen bleach or a peroxy-based or generating system. The peroxygen bleach is preferably a compound which is capable of yielding hydrogen peroxide in aqueous solution although it is possible to use more complex systems which involve peracids and/or peracid precursors.

Hydrogen peroxide sources are well known in the art. They include the inorganic peroxides, for example alkali metal peroxides, organic peroxides for example as urea peroxide, and inorganic persalts, such as the alkali metal perborates, percarbonates, perphosphates, persilicates and persulphates. Mixtures of two or more such compounds may also be suitable.

Typical levels of peroxygen source in fully formulated composition will range from 0.05-55 wt. % with 1-40 wt. % being particularly preferred and 1-25 wt. % being most particularly preferred.

Typical levels of peroxygen source (as hydrogen peroxide equivalents) in fully formulated composition will be such that the in-use concentration will range from 0.005 mM to 100 mM with 0.025 mM to 50 mM being particularly preferred and 0.05 mM to 10 mM being most particularly preferred.

Preferred peroxygen sources include percarbonate and perborate.

Particularly preferred are sodium perborate tetrahydrate and, especially, sodium perborate monohydrate. Sodium perborate monohydrate is preferred because of its high active oxygen content. Typical levels of perborate in compositions according to the invention range from 0.5-15% wt/product. Sodium percarbonate may also be preferred for environmental reasons.

Peroxyacid bleach precursors are also known and amply described in literature, such as in GB-A-836988; GB-A-864,798; GB-A-907,356; GB-A-1,003,310 and GB-A-1,519,351; DE-A-3,337,921; EP-A-0,185,522; EP-A-0,174,132; EP-A-0,120,591; and U.S. Pat. No. 1,246,339; U.S. Pat. No. 3,332,882; U.S. Pat. No. 4,128,494; U.S. Pat. No. 4,412,934 and U.S. Pat. No. 4,675,393.

Another useful class of peroxyacid bleach precursors is that of the cationic i.e. quaternary ammonium substituted peroxyacid precursors as disclosed in U.S. Pat. No. 4,751,015 and U.S. Pat. No. 4,397,757, in EP-A-0,284,292 and EP-A-331,229. Examples of peroxyacid bleach precursors of this class are:
2-(N,N,N-trimethyl ammonium) ethyl sodium-4-sulphophenyl carbonate chloride—(SPCC);
N-octyl,N,N-dimethyl-N₁₀-carbophenoxy decyl ammonium chloride—(ODC);
3-(N,N,N-trimethyl ammonium) propyl sodium-4-sulphophenyl carboxylate; and
N,N,N-trimethyl ammonium toluyloxy benzene sulphonate.

A further special class of bleach precursors is formed by the cationic nitrites as disclosed in EP-A-303,520; EP-A-458,396 and EP-A-464,880.

Of the above classes of bleach precursors, the preferred classes are the esters, including acyl phenol sulphonates and acyl alkyl phenol sulphonates; the acyl-amides; and the quaternary ammonium substituted peroxyacid precursors including the cationic nitrites.

Examples of said preferred peroxyacid bleach precursors or activators are:
sodium-4-benzoyloxy benzene sulphonate (SBOBS); N,N,N′N′-tetraacetyl ethylene diamine (TAED);
sodium-1-methyl-2-benzoyloxy benzene-4-sulphonate; sodium-4-methyl-3-benzoloxy benzoate;
2-(N,N,N-trimethyl ammonium) ethyl sodium-4-sulphophenyl carbonate chloride (SPCC);
trimethyl ammonium toluyloxy-benzene sulphonate; sodium nonanoyloxybenzene sulphonate (SNOBS);
sodium 3,5,5-trimethyl hexanoyl-oxybenzene sulphonate (STHOBS); and
the substituted cationic nitrites.

Of the peracid precursors, TAED and SNOBS are preferred.

Where present the precursors are typically used in an amount of up to 12%, more preferably from 0.5-5% by weight of the composition.

Radical Initiators:

Preferably the radical initiators are selected from hydrogen abstraction radical photo-initiators, bond-cleavage radical photo-initiators and mixtures thereof.

Oligomeric radical photo-initiators are preferred.

Hydrogen abstraction radical photo-initiators operate according to the following reaction: 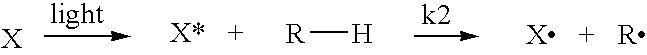
where X is the radical photo-initiator and R—H is a hydrogen donating compound.

Suitable examples of hydrogen abstraction radical photoinitiators X can be found among the benzophenones, acetophenones, pyrazines, quinones and benzils.

Suitable examples of hydrogen donating compounds R—H include organic molecules containing an aliphatic C—H group and include propan-2-ol, and compounds comprising a cellulose, polyester, or nylon backbone, for example.

k1 is the rate constant of the hydrogen abstraction reaction. Preferably, the rate constant k1 is greater than 10⁴ mol⁻¹ ls⁻¹ when RH is propan-2-ol.

Bond cleavage radical photoinitiators operate according to the following reaction:

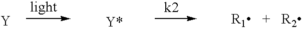

k2 is the rate constant of the bond-cleavage reaction. Preferably, k2 is greater than 10⁶ s⁻¹.

Suitable bond cleavage radical initiators may be selected from the following groups:
(a) alpha amino ketones, particularly those containing a benzoyl moiety, otherwise called alpha-amino acetophenones, for example 2-methyl 1-[4-phenyl]-2-morpholinopropan-1-one (Irgacure 907, trade mark), (2-benzyl-2-dimethyl amino-1-(4-morpholinophenyl)-butan-1-one (Irgacure 369, trade mark);
(b) alphahydroxy ketones, particularly alpha-hydroxy acetophenones, eg (1-[4-(2-hydroxyethoxy)-phenyl]-2-hydroxy-2-methyl-1-propan-1-one) (Irgacure 2959, trade mark), 1-hydroxy-cyclohexyl-phenyl-ketone (Irgacure 184, trade mark), oligo[2-hydroxy 2-methyl-1-[4(1-methyl)phenyl]propanone (Esacure KIP 150, trade mark);
(c) phosphorus-containing photoinitiators, including monoacyl and bisacyl phosphine oxide and sulphides, for example 2-4-6-(trimethylbenzoyl)diphenyl-phosphine oxide, bis(2,4,6-trimethylbenzoyl)-phenyl-phosphine oxide (Irgacure 819, trade mark), (2,4,6-trimethylbenzoyl)phenyl phosphinic acid ethyl ester (Lucirin TPO-L (trade mark) ex BASF);
(d) dialkoxy acetophenones;
(e) alpha-haloacetophenones; and
(f) trisacyl phosphine oxides.
(g) benzoin and benzoin based photoinitiators

Suitable radical photoinitiators are disclosed in WO 9607662 (trisacyl phosphine oxides), U.S. Pat. No. 5,399,782 (phosphine sulphides), U.S. Pat. No. 5,410,060, EP-A-57474, EP-A-73413 (phosphine oxides), EP-A-088050, EP-A-0117233, EP-A-0138754, EP-A-0446175 and U.S. Pat. No. 4,559,371.

Suitable photoinitiators are disclosed for example in EP-A-0003002 in the name of Ciba Geigy, EP-A-0446175 in the name of Ciba Geigy, GB 2259704 in the name of Ciba Geigy (alkyl bisacyl phosphine oxides), U.S. Pat. No. 4,792,632 (bisacyl phosphine oxides), U.S. Pat. No. 5,554,663 in the name of Ciba Geigy (alpha amino acetophenones), U.S. Pat. No. 5,767,169 (alkoxy phenyl substituted bisacyl phosphine oxides) and U.S. Pat. No. 4,719,297 (acylphosphine compounds).

Radical photoinitiators are discussed in general in A. F. Cunningham, V. Desorby, K. Dietliker, R. Husler and D. G. Leppard, Chemia 48 (1994) 423-426. They are discussed in H. F. Gruber Prog. Polym. Sci. 17(1992) 953-1044.

Without wishing to be bound by theory, it is preferred that the radical photo-initiators all react through their excited triplet state, to reduce the influence of the cage effect.

The radical photo-initiator suitably undergoes one of the reactions set out above when excited by radiation falling generally in the range 290-800 nm. For example, natural sunlight, which comprises light in this region, will be suitable for causing the radical photo-initiator to undergo one of the reactions described above.

Preferably, the radical photo initiator has a maximum extinction coefficient in the ultraviolet range (290-400 nm) which is greater than 100 mol⁻¹ lcm⁻¹. Suitably, the radical photo initiator is a solid or a liquid at room temperature.

The method of the invention preferably comprises a step of exposing the treated fabric to light, more preferably sunlight, even more preferably direct sunlight. When the method is carried out as part of a laundering process, the exposure to light conveniently involves drying the fabric in sunlight. However, the treated fabric can be exposed to light in other ways, such as, for example, using a source of artificial light.

Preferably, the treated fabric is exposed to light until the stain is removed or all photo initiator has reacted. It will be appreciated that the time taken for stain removal and/or substantially complete reaction of the photo initiator will depend on the intensity of the light. In typical terrestrial light conditions, the time of exposure may, for example, range from a few seconds to a few days, preferably 1 second to 6 hours.

Suitably, the radical initiator is substantially colourless and gives non-coloured products upon undergoing one of the reactions set out above.

Preferably, the radical initiators have a high log P value, where log P is the octanol-water partition coefficient. It is preferred that the radical initiators have a log P measured at 25° C. in excess of 2.5 and more preferably in excess of 4.0.

Suitable levels of initiator are 0.01-2% wt, more preferably 0.05-1% wt on composition.

Builders:

The compositions of the invention preferably contain a detergency builder. This is preferably present in an amount of from about 5 to 80% by weight, preferably from about 10 to 60% by weight.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as;
sodium tripolyphosphate;
nitrilotriacetic acid and its water-soluble salts;
the alkali metal salts of carboxymethyloxy succinic acid, ethylene diamine tetraacetic acid, oxydisuccinic acid, mellitic acid, benzene polycarboxylic acids, citric acid; and;
polyacetal carboxylates as disclosed in U.S. Pat. No. 4,144,226 and U.S. Pat. No. 4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the composition may contain any one of the organic and inorganic builder materials, though, for environmental reasons, phosphate builders are preferably omitted or only used in very small amounts.

Typical builders usable in the present invention are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

Surfactant:

Typically the compositions of the invention will further comprise a surfactant.

A preferred surfactant comprises an alkyl benzene sulphonate (ABS). Suitable ABS compounds which may be used are water-soluble alkali metal salts of organic sulphonates having alkyl radicals containing from about 8 to about 22 carbon atoms, the term alkyl being used to include the alkyl portion of higher acyl radicals.

The ABS surfactants as commercially supplied are believed to contain a significant quantity of hydroperoxyl compounds. In certain embodiments of the invention it is not necessary to use added peroxygen sources if ABS is present.

Particularly preferred surfactant compounds are sodium and potassium alkyl C₉-C₂₀ benzene sulphonates, particularly sodium linear secondary alkyl C₁₀-C₁₅ benzene sulphonates. The most preferred anionic detergent compounds are sodium C₁₁-C₁₅ alkyl benzene sulphonates.

Other surfactants may be present in the compositions of the invention. Preferably these are anionic surfactants. Examples of suitable synthetic anionic surfactants include:
sodium and ammonium alkyl sulphates, especially those obtained by sulphating higher (C₈-C₁₈) alcohols produced, for example, from tallow or coconut oil;
sodium alkyl glyceryl ether sulphates, especially those ethers of the higher alcohols derived from tallow or coconut oil fatty acid mono-glyceride sulphates and sulphonates;
sodium and ammonium salts of sulphuric acid esters of higher (C₉-C₁₈) fatty alcohol alkylene oxide, particularly ethylene oxide, reaction products;
the reaction products of fatty acids such as coconut fatty acids esterified with isethionic acid and neutralised with sodium hydroxide;
sodium and ammonium salts of fatty acid amides of methyl taurine;
alkane mono-sulphonates such as those derived by reacting alpha-olefins (C₈-C₂₀) with sodium bisulphite and those derived by reacting paraffins with SO₂ and Cl₂ and then hydrolysing with a base to produce a random sulphonate;
sodium and ammonium (C₇-C₁₂) dialkyl sulphosuccinates; and;
olefin sulphonates, which term is used to describe material made by reacting olefins, particularly (C₁₀-C₂₀) alpha-olefins, with SO₃ and then neutralising and hydrolysing the reaction product.

The compositions of the invention may also comprise nonionic surfactants. It is believed that even in the presence of anionic surfactant the metal-ligand bleaching catalysts become less effective at very high levels of nonionic. However low to moderate levels of nonionic surfactants can be present to confer cleaning benefits.

Examples of suitable nonionic surface-active compounds which may be used, preferably together with the anionic surface-active compounds, include, in particular;
the reaction products of alkylene oxides, usually ethylene oxide, with alkyl (C₆-C₂₂) phenols, generally 5-25 EO, i.e. 5-25 units of ethylene oxides per molecule; and;
the condensation products of aliphatic (C₈-C₁₈) primary or secondary linear or branched alcohols with ethylene oxide, generally 2-30 EO.

Other so-called nonionic surface-actives include alkyl polyglycosides, sugar esters, long-chain tertiary amine oxides, long-chain tertiary phosphine oxides and dialkyl sulphoxides.

Preferably the surfactant is present in the composition in an amount such that a unit dose provides at least 0.05, more preferably at least 0.1, most preferably at least 0.2 g/l concentration of the surfactant compound in a wash.

Other Components:

It is advantageous for the compositions of the invention to comprise at least one nitrogen-containing, dye binding, DTI polymers. Of these polymers and co-polymers of cyclic amines such as vinyl pyrrolidone, and/or vinyl imidazole are preferred. Suitable polymers include polyvinyl pyrrolidone polymers, polyamine N-oxide polymers, copolymers of N-vinylpyrrolidone and N-vinylimidazole, and polymers of N-carboxymethyl-4-vinylpyridinium chloride. Most preferably the composition according to the present invention comprises a dye transfer inhibition agent selected from poly vinyl-pyrridine N-oxide (PVPy-NO), polyvinyl pyrrolidone (PVP), polyvinyl imidazole, N-vinylpyrrolidone and N-vinylimidazole copolymers (PVP/PVI), copolymers thereof, and mixtures thereof.

The amount of dye transfer inhibition agent in the composition according to the present invention will be from 0.01 to 10%, preferably from 0.02 to 5%, more preferably from 0.03 to 2%, by weight of the composition.

Apart from the components already mentioned, the composition can contain any of the conventional additives in amounts of which such materials are normally employed in fabric washing detergent compositions.

Examples of these additives include;
buffers such as carbonates;
lather boosters, such as alkanolamides, particularly the monoethanol amides derived from palmkernel fatty acids and coconut fatty acids;
lather depressants, such as alkyl phosphates and silicones;
anti-redeposition agents, such as sodium carboxymethyl cellulose and alkyl or substituted alkyl cellulose ethers;
stabilisers, such as phosphonic acid derivatives (i.e. Dequest® types);
fabric softening agents;
inorganic salts and alkaline buffering agents, such as sodium sulphate and sodium silicate;
and, usually in very small amounts, fluorescent agents; perfumes; enzymes, such as proteases, cellulases, lipases, amylases and oxidases; germicides and colourants.

In order that the invention may be further and better understood it will be described in detail with reference to following non-limiting examples:

### EXAMPLES

The catalyst referred to in the examples is the Fe complex of 3,4,8,9-tetrahydro-3,3,6,6,9,9-hexamethyl-1H-1,4,8,11-benzo-tetraazocyclotri-decane-2,5,7,10 (6H,11H) tetrone, with lithium as the counter-ion and water as the axial ligand. This was synthesised in accordance with the method set out in our co-pending patent application GB 0020846.2.

The radical photo-initiator used was Esacure™ KIP-150 (ex. Lamberti Spa) an oligomeric poly-functional alpha hydroxy ketone.

Light exposures were performed in an Atlas S3000 Xenon Weather-o-meter™ (WOM), which simulates average Florida sunlight.

### Example 1

Four separate stains on white woven cotton cloth (10 cm by 10 cm) were created as follows:
(a) A saturated solution of the spice turmeric was created in extra virgin olive oil. 0.5 ml of this was pipetted onto cloth.
(b) An oily tomato sauce was made by heating to the boil a 15:15:14 weight mixture of extra virgin olive oil, tomato paste and water. 1 ml of the sauce was then smeared onto cloth to make a 5 cm diameter circle.
(c) A 5 cm diameter circle of Colemans™ mustard was smeared onto cloth.
(d) A 0.02% weight solution of beta-carotene in extra virgin olive oil was made. 0.5 ml of this was pipetted into the cloth.

Once made all the stains were aged for 24 hours in the dark then each stain type separately washed, rinsed and irradiated for 12 minutes in the WOM.

The wash conditions were 40° C.; 30 minute wash with a liquor to cloth ration of 10:1; 4 stained cloths and 8 clean white cloths per wash; 7 g/l Persil™ Colour Powder (ex. Lever-Faberge GB, this product does not contain any bleach).

After the wash/rinse/irradiation the residual stain on the stained clothes was measured using a reflectance spectrometer and expressed as a ΔE value relative to clean white cloth.

In parallel to the above experiment, identical washes were performed in which:
(i) 1 micromoles per litre of catalyst and 1 millimoles per litre of hydrogen peroxide were added to the wash.
(ii) 0.014 g/l of Esacure KIP-150 was added to the wash liquor as a 50:50 mix with the nonionic surfactant Synperionic A7™ (ex ICI surfactants) p1 (iii) both catalyst, photo-initiator and peroxide were added in the amounts given in (i) & (ii).

All the stains used in these experiments were made at the same time and checked before washing to ensure they were identically stained.

The average results of the experiments are given in table 1 below, also given is the average value of the four stains.

TABLE 1

| | ΔE of stains after wash/rinse/irradiate | | | |
|---|---|---|---|---|
| | | | | (iii) |
| | Powder | (i) | (ii) | +Catalyst |
| | only | +Catalyst | +Initiator | +Initiator |
| (a) | 30.4 | 10.1 | 25.7 | 3.4 |
| Turmeric | | | | |
| (b) | 18.2 | 22.1 | 4.1 | 1.7 |
| Tomato | | | | |
| (c) | 14.5 | 11.7 | 14.5 | 9.5 |
| Mustard | | | | |
| (d) | 18.1 | 14.9 | 1.2 | 0.5 |
| β-carotene | | | | |
| Average | 20.3 | 14.7 | 11.4 | 3.8 |

From the results it is clearly seen that a combination of catalyst plus photo-initiator provides the best stain removal by far for all 4 stains. The combined effect is much greater than would be expected from the results where the catalyst and photoinitiators are used separately. This is particularly clear in the case of stain (c) where no benefit was obtained with the radical initiator alone although the combination of the initiator with the catalyst gave a greater benefit than the catalyst alone.

Delta E values of less than 1-2 are difficult to perceive with the unaided eye. In the case of stain (d) the 0.5 result means that the stain has been almost completely removed by the bleaching system. This low a value of delta E would mean that no stain would be visible to the eye on the test cloths.

### Example 2

The experiment of example 1 was repeated using the (a) and (d) stains. In this case the stains were washed together (ratio of 1:1) and this simulates the complex effects that are found in real washes due to the presence of a variety of different stains. These interaction can substantial change the stain removal effects observable, as shown in table 2.

TABLE 2

| | ΔE of stains after wash/rinse/irradiate | | | |
|---|---|---|---|---|
| | | | | (iii) |
| | Powder | (i) | (ii) | +Catalyst |
| | only | +Catalyst | +Initiator | +Initiator |
| (a) | 36.9 | 11.6 | 33.1 | 5.6 |
| Turmeric | | | | |
| (d) | 29.4 | 16.0 | 17.4 | 0.7 |
| β-carotene | | | | |
| Average | 33.2 | 13.8 | 25.3 | 3.2 |

From the results it is again seen that a combination of catalyst plus photo-initiator provides the best stain removal by far for both stains. The combined effect is much greater than expected from the results where the catalyst and photoinitiators are used separately.

1. A bleaching composition which comprises:
a) a macrocyclic (tetra) amido N-donor ligand which forms a complex with a transition metal, the ligand metal complex being capable of catalysing bleaching of dyestuffs in solution, and,
b) a radical initiator.

2. The bleaching composition according to claim 1, wherein alkyl benzene sulphonate surfactant is present in the composition in an amount sufficient to provide a concentration in a wash liquor of at least 0.05 g/l.

3. The bleaching composition according to claim 1 wherein the metal-ligand is that having the structure as shown below: 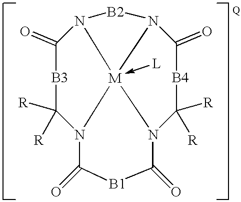
wherein:
B₁, B₃ and B₄ each represent a bridging group having zero, ones two or three carbon containing nodes for substitution, and B₂ represents a bridging group having at least one carbon containing node for substitution, each said node containing a C(R), C(R₁)(R₂) or C(R)₂,
each R substituent is the same is the same or different from the remaining R substituents, and
(i) is selected from the group consisting of alkyl, alkenyl, cycloalkyl, cycloalkenyl, aryl, alkynyl, alkylaryl, halogen, alkoxy, phenoxy and combinations thereof, or
(ii) form a substituted or unsubstituted benzene ring of which two carbons on the ring form nodes in the B-unit;
M is a transition metal ion;
L is an axial ligand; and,
Q is an alkali metal or tetra-alkyl ammonium or tetra-phenyl phosphonium counter-ion.

4. The bleaching composition according to claim 3 wherein the ligand is 5,6-benzo-3,8,11,1 3-tetraoxo-2,2,9,9,12,1 2-hexamethyl-1,4,7,10-tetraaza-cyclo-tridecane.

5. The bleaching composition according to claim 1 wherein the wherein the radical initiator is a radical photo-initiator, preferably an oligomeric radical photo-initiator.

6. The bleaching composition according to claim 5 wherein the radical initiator is selected from hydrogen abstraction photo-initiators, bond-cleavage radical photo-initiators and mixtures thereof.

7. The bleaching composition according to claim 6, wherein the radical photo-initiator is selected from the group consisting of benzophenones, acetophenones, pyrazines, quinones, benzils and mixtures thereof.

8. The bleaching composition according to claim 6, wherein the radical photo-initiator is selected from the group consisting of alpha amino ketones, alpha-amino acetophenones, alpha-hydroxy ketones, alpha-hydroxy acetophenones, monoacyl and bisacyl phosphine oxides and sulphides, dialkoxy acetophenones, alpha-halo acetylphenones, triacylphosphine oxides, benzoin and benzoin based photoinitiators and mixtures thereof.

9. The bleaching composition according to claim 1 wherein the radical initiator has a log P measured at 25° C. in excess of 2.5.

10. A method of treating fabric comprising treating the fabric with a composition comprised of:
a macrocyclic (tetra) amido N-donor ligand which forms a complex with a transition metal, the ligand metal complex being capable of catalyzing the bleaching of dyestuffs in solution, and
a radical initiator.

11. The method according to claim 10, wherein the step of treating of fabric takes place during a fabric washing process and the fabric is dried while exposed to daylight.
